(19) United States
(12) Patent Application Publication
(10) Pub. No.: US 2021/0001344 A1
(43) Pub. Date: Jan. 7, 2021

(54) SAMPLE HOLDING DISC FOR CENTRIFUGATION

(71) Applicant: SHIMADZU CORPORATION, Kyoto-shi (JP)

(72) Inventors: Ippei TAKEUCHI, Kyoto-shi (JP); Shinobu KUDOH, Kyoto-shi (JP)

(73) Assignee: SHIMADZU CORPORATION, Kyoto-shi (JP)

(21) Appl. No.: 16/502,422

(22) Filed: Jul. 3, 2019

(51) Int. Cl. B01L 9/00; B04B 15/00

(52) U.S. Cl. CPC B01L 9/527; B04B 15/00; B01L 2300/0803; B01L 2200/025; B01L 2300/021; B01L 2200/141

(57) ABSTRACT

A sample holding disc includes a disk-shaped substrate, a plurality of holders for centrifugation including a recess configured to fit a sampling tip in a state where a flow channel of the sampling tip is substantially horizontal and a proximal end side faces the center, and a holder for keeping which includes a groove provided corresponding to each of the holders for centrifugation on an upper surface of the disk-shaped substrate and in which a distal end side of the sampling tip is fitted and held in a state where the proximal end of the sampling tip faces upward.

### TECHNICAL FIELD

The present invention relates to a sample holding disc for centrifugation, which is configured to install a sampling tip after collection of a sample.

### BACKGROUND ART

With a conventional centrifuge tube having a capacity of several milliliters or greater, collecting a minute quantity of blood and transferring only supernatant blood plasma components with a micropipette or the like after centrifugal processing while avoiding mixing of blood cell components into the supernatant becomes much more difficult as the quantity of the sample is smaller.

As an instrument for collecting blood plasma components from a minute quantity of a blood sample, a minute quantity-blood collection tube which is a capillary with its opposite ends opened has been used. In collecting blood plasma components using the minute quantity-blood collection tube, blood is drawn into the minute quantity-blood collection tube, the tip is sealed with putty or the like, and then the collection tube is transferred to another container and centrifuged. Thereafter, about the interface between the blood plasma part and the blood cell part, the collection tube is broken by being snapped off, and just blood plasma components are transferred to a separately prepared capillary with a fixed volume and thereby extracted. The extracted blood plasma components are appropriately treated and then analyzed by TLC (thin-layer chromatography), LC (liquid chromatography), LC/MS (liquid chromatography/mass spectrometer), mass spectrometer, or the like.

Also proposed is a centrifuge tube intended to collect only a minute quantity of a white blood cell part which is positioned between a blood cell part and a blood plasma part having been centrifuged (see Patent Document 1). The centrifuge tube includes two upper and lower reservoirs having a great diameter and a large capacity, and a small-capacity reservoir having a small diameter and positioned between the upper and lower reservoirs. The lower large-capacity reservoir is bottomed, and the upper large-capacity reservoir is opened by an opening. Blood is collected from the upper opening by a predetermined quantity, and centrifuged. As a result, the white blood cell part is positioned in the small-capacity reservoir. After the centrifugal processing, a fine glass tube (capillary) is inserted from the upper opening, and the white blood cell components in the small-capacity reservoir are collected.

Studies are also actively conducted in which: several flow channels including capillaries are provided in a disc; the disc is subjected to centrifugal processing whereby blood components are separated; and the blood components are caused to react with a reagent so as to be detected. As a device used for such a scheme, for example, a device formed by a disc-shaped member having integrally formed chamber, flow channels, reservoir, and analysis cells is proposed (see Patent Document 2). A blood sample is introduced into the device and centrifuged so as to separate blood cells from serum. Subsequently, the serum undergoes several processing operations or tests.

### PRIOR ART DOCUMENTS

### Patent Documents

Patent Document 1: Japanese Patent Laid-open Publication No. 01-199159
Patent Document 2: Japanese Patent Laid-open Publication (Translation of PCT Application) No. 2001-502793

### SUMMARY OF THE INVENTION

### Problems to be Solved by the Invention

In preclinical study conducted in drug development, the quantity of blood obtained from a small animal is limited. Accordingly, it is difficult to collect blood from an individual animal at every time point required for a pharmacokinetic analysis. Therefore, animals are allocated among blood collection time points after drug administration, so that samples can be collected at different time points from respective animals. Recent sophistication of the apparatuses has drastically improved the measurement sensitivity. Nowadays, just a minute quantity of a sample will suffice for measurement. Thus, if blood plasma or serum can be directly and easily obtained by a constant volume required for measurement from a minute quantity of blood, the quantity of blood that must be collected for a measurement can be reduced to a very small quantity. This contributes to a reduction in the number of sacrificed animals. In addition, since a series of samples can be obtained from a single individual, individual difference variations are avoided from measurement data. Further, in clinical trials and clinical settings as well, replacing blood collection by a great quantity using a needle, the apparatuses are applicable to easy collection of a sample from a peripheral blood vessel of ears, hands, belly, and the like. This contributes to a significant reduction of burden of blood collection put on infants, children, or patients.

The present invention is directed to a sampling tip capable of accurately collecting a very minute quantity of a sample. It is common practice that after a sample such as blood is collected from a specimen, in order to cool the sample until the sample is separated into blood plasma or serum by using a means such as centrifugation, an instrument in which the sample is collected is stored on ice. In the case of a sampling tip for collecting a minute quantity of a sample, although it is conceivable to place the tip on ice as it is to cool the sample, if this is done, a sampling port provided in the tip may be directly in contact with the ice, which may cause contamination and the like.

Thus, an object of the present invention is to provide a sample holding disc for centrifugation which can store a sampling tip after sample collection while preventing occurrence of contamination and the like.

### Solutions to the Problems

A sampling tip targeted by a sample holding disc for centrifugation according to the present invention has an opening, serving as a sample intake port, at its proximal end and includes a flow channel holding a sample drawn from the opening, the flow channel has two flow channel portions connected on a distal end side and extending from the distal end side to a proximal end side, one of the flow channel portions leads to the sample intake port, and the other flow channel portion terminates at a position not reaching the proximal end. The sample holding disc for centrifugation according to the present invention includes a disk-shaped substrate, a plurality of holders for centrifugation including a recess provided on an upper surface of the disk-shaped substrate and configured to fit the sampling tip in a state where the flow channel of the sampling tip is substantially horizontal and the proximal end side faces the center, and a holder for keeping which includes a groove provided corresponding to each of the holders for centrifugation on the upper surface of the disk-shaped substrate and in which the distal end side of the sampling tip is fitted and held in a state where the proximal end of the sampling tip faces upward.

The holder for keeping is preferably a through groove capable of causing the distal end of the sampling tip to reach a height equal to or lower than a lower surface of the disk-shaped substrate. As described above, after a sample such as blood is collected from a specimen, until the sample is separated into blood plasma or serum by using a means such as centrifugation, the sample may be stored on ice. In the sample holding disc of the present invention, if the holder for keeping is the through groove capable of causing the distal end of the sampling tip to reach the height equal to or lower than the lower surface of the disk-shaped substrate, when the sample holding disc is placed on ice, the distal end of the sampling tip can be brought into direct contact with the ice, and therefore, cooling efficiency of the sample is improved.

Preferably, identification information is attached to each of the holders for storage so as to be distinguishable from other holders for storage. This facilitates management of the sample.

Preferably, a portion of a bottom surface of the holder for centrifugation, which corresponds to the proximal end of the sampling tip, is lower than the other portion so that the portion does not come into contact with the proximal end of the sampling tip. Thus, the sample is prevented from adhering to the bottom surface of the holder for centrifugation, and occurrence of contamination can be prevented.

Preferably, a hole for fixing a rotation shaft is provided at a central portion of the disk-shaped substrate. Thus, the sample can be centrifuged as the sample holding disc in which the sampling tip is installed in the holder for centrifugation is installed in a centrifuge as it is.

### Effects of the Invention

The sample holding disc for centrifugation of the present invention includes a holder for keeping, in which the distal end side of the sampling tip is fitted and held in a state where the proximal end of the sampling tip faces upward, in such a way that the holder for keeping corresponds to each of the holders for centrifugation configured to fit the sampling tip in a state where the flow channel of the sampling tip is substantially horizontal and the proximal end side faces the center, and therefore, the sampling tip after sample collection can be held at a position corresponding to the holder for centrifugation in a state where the sampling tip is erected in such a way that the proximal end side provided with a sample intake port is an upper side. Consequently, the sampling tip after sample collection can be stored while preventing occurrence of contamination. Since the sampling tip can be stored in a state of being erected vertically, separation of the sample is promoted by gravity, and the time required for centrifugation can be shortened compared to when the sampling tip is stored in a horizontal state.

### BRIEF DESCRIPTION OF THE DRAWINGS

FIG. 1A is a plan view showing an embodiment of a sample holding disc for centrifugation.

FIG. 1B is a cross-sectional view at the X-X′ position of the embodiment.

FIG. 1C is a partial cross-sectional view showing a state where a sampling tip is embedded in a penetration groove of the embodiment.

FIG. 2A is a perspective view showing an example of the sampling tip installed in the holder of the embodiment.

FIG. 2B is a plan view of the sampling tip.

FIG. 2C is a side view of the sampling tip.

### EMBODIMENT OF THE INVENTION

Hereinafter, an embodiment of a sample holding disc for centrifugation (hereinafter simply referred to as a sample holding disc) will be described with reference to the drawings.

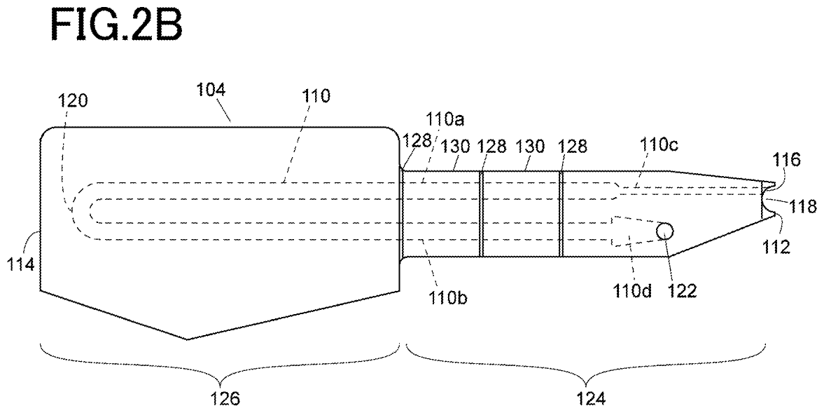

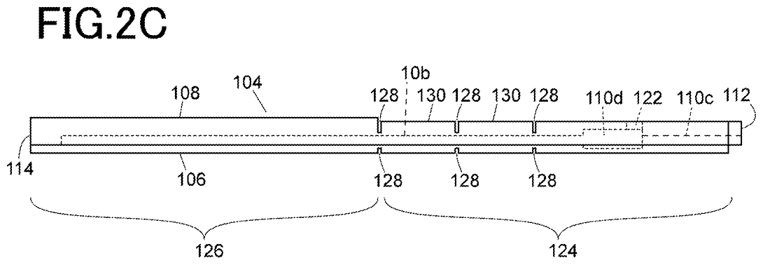

First, an example of a sampling tip installed in the sample holding disc will be described with reference to FIGS. 2A to 2C.

A sampling tip 102 includes a tip body 104, and the tip body 104 is constituted of a lower substrate 106 and an upper substrate 108. The lower substrate 106 and the upper substrate 108 are integrated by bonding to constitute the tip body 104. A flow channel 110 for sample collection is formed on a bonding surface of the upper substrate 108, and the flow channel 110 is disposed in the tip body 104 by the lower substrate 106 and the upper substrate 108 being bonded.

The tip body 104 has a proximal end 112 and a distal end 114. The sampling tip 102 draws an sample and then subjects the sample to centrifugal processing, and at this time, the sampling tip 102 is attached to a centrifuge such that centrifugal force acts in a direction from the proximal end 112 to the distal end 114. The terms “proximal end” and “distal end” of the tip body 104 are determined based on the direction of the centrifugal force.

The tip body 104 has a sample intake port 116 on its proximal end side. The sample intake port 116 is provided as an opening leading to an inside of a recess 118 provided at the proximal end 112 of the tip body 104. The recess 118 is for facilitating sample drawing from the sample intake port 116 when the distal end 114 is brought into contact with a sample such as blood during sampling.

The flow channel 110 is thin enough to draw a sample by means of the capillary phenomenon. The flow channel 110 has two flow channel portions 110a and 110b connected by a connecting portion 120 on the distal end side in the tip body 104 and extending from the distal end side to the proximal end side. The flow channel portion 110a has an introduction flow channel 110c, and the introduction flow channel 110c leading to the sample intake port 16. The flow channel portion 110b terminates at a position not reaching the proximal end 112.

A liquid pool space 110d is provided at a terminal of the flow channel portion 110b. The liquid pool space 110d has a cross-sectional area of such a size that a liquid is not drawn by means of the capillary phenomenon at at least a portion of its entrance (an end on the distal end side of the liquid pool space 10d), and an air hole 122 leads to an end on the proximal end side of the liquid pool space 110d. The liquid pool space 110d has an internal volume equal to or greater than an internal volume of a portion of the introduction flow channel 110c of the flow channel portion 110a that is on the more proximal end side (upper side in the drawing) than the air hole 122.

A cross-sectional area of the entrance portion of the liquid pool space 110d is, for example, twice or more the size of a cross-sectional area of the other portion of the flow channel portion 110b. As an example of a cross-sectional dimension of the entrance portion of the liquid pool space 10d, the cross-sectional dimension is about 3 mm in width and about 1.5 mm in depth.

The advantages of providing the liquid pool space 110d at the terminal of the flow channel portion 110b include the following.

First, in the liquid pool space 110d, a sample is not drawn by means of the capillary phenomenon, and therefore, the sample drawn from the sample intake port 116 stops at the entrance portion of the liquid pool space 110d without reaching the position of the air hole 122. Thus, the quantity of sampling in the flow channel portions 110a and 110b can be secured without increasing the quantity of sample collected in an extractor 110.

Furthermore, since the sample drawn from the sample intake port 116 stops at the entrance portion of the liquid pool space 110d, no sample is present in the liquid pool space 110d before centrifugation is performed. By making an inner surface of the liquid pool space 110d hydrophobic, the sample can be more reliably stopped at the entrance portion of the liquid pool space 110d. When centrifugation is performed in this state, an excess sample due to the fact that the sample is in equilibrium is stored in the liquid pool space 110d. Since the liquid pool space 110d has an internal volume equal to or greater than the internal volume of the portion of the introduction flow channel 110c of the flow channel portion 110a that is on the more proximal end side (upper side in the drawing) than the air hole 122, all the excess sample is stored in the liquid pool space 110d. As a result, the excess sample can be prevented from overflowing from the flow channel portion 110b and being discharged from the air hole 122.

A collector 124 includes an extraction portion 130, which can be cut by a cutting portion 128, at a position on the more distal end side than the air hole 122. The cutting portion 128 is a groove which is thinner in this embodiment than the other portion of the tip body 104, and the extraction portion 130 is defined by the two cutting portions 128 parallel to each other. The cutting portion 128 is formed in a direction orthogonal to the longitudinal direction of the collector 124 (the direction from the proximal end 112 to the distal end 114) and extends over the entire width of the collector 124. The extraction portion 130 includes the two flow channel portions 110a and 110b. The cutting portion 128 is not limited to the groove as in this embodiment, it is only necessary that the strength of the portion is weak so that the portion can be broken with fingertips, and, for example, the width of the portion may be narrow.

Since a position where the extraction portion 130 is disposed in the collector 124 is on the proximal end side, when the collected sample is subjected to centrifugal processing, a component of smaller specific gravity having been centrifuged is located in the extraction portion 130. For example, the position of the extraction portion 130 in the flow channel 110 is set in such a way that when blood is collected as a sample and centrifugal processing is performed in such a way that a direction from the proximal end side to the distal end side of a sampling tip 2 is a direction in which the centrifugal force acts, the extraction portion 130 receives blood plasma components or serum components.

A wide portion 126 has such a size that identification information such as the name and number of the sample collected in the sampling tip can be written or a label with the identification information can be attached. The wide portion 126 can also be used as a grip when the sampling tip is held.

The sampling tip 102 is formed of, for example, a resin material. While the resin material is not particularly limited, it may be COP (cyclo-olefin polymers), PMMA (polymethyl methacrylate resin), PP (polypropylene resin), PC (polycarbonate resin), PVA (polyvinyl alcohol) or the like.

Since the flow channel 110 draws in a liquid sample from the sample intake port 116 by means of the capillary phenomenon, the cross-sectional area of the flow channel 110 is set to be small enough to cause the capillary phenomenon to occur, and in addition, an inner surface of the flow channel 110 is required to be hydrophilic when the sample is blood or an aqueous solution. Since the resin material exemplarily noted above is hydrophobic, preferably the inner surface of the flow channel 110 and the sample intake port 116 are treated to become hydrophilic.

When the sample is blood, preferably, an anticoagulant for preventing coagulation of blood is provided on the inner surface of the flow channel 110 in order to draw the blood directly from the sample and collect blood plasma in the extraction portion 130 by centrifugation. The anticoagulant may be coated on the inner surface of the flow channel 110 coated with hydrophilic polymer.

In the sampling tip 102, in order to use the extraction portion 130 for analysis after centrifugation, the extraction portion 130 is separated from the tip body 104 and becomes two individual extraction portions 130. To separate at the cutting portion 128, the tip body 104 is broken at the position of the cutting portion 128. Thus, two samples for analysis can be obtained from one tip body 104.

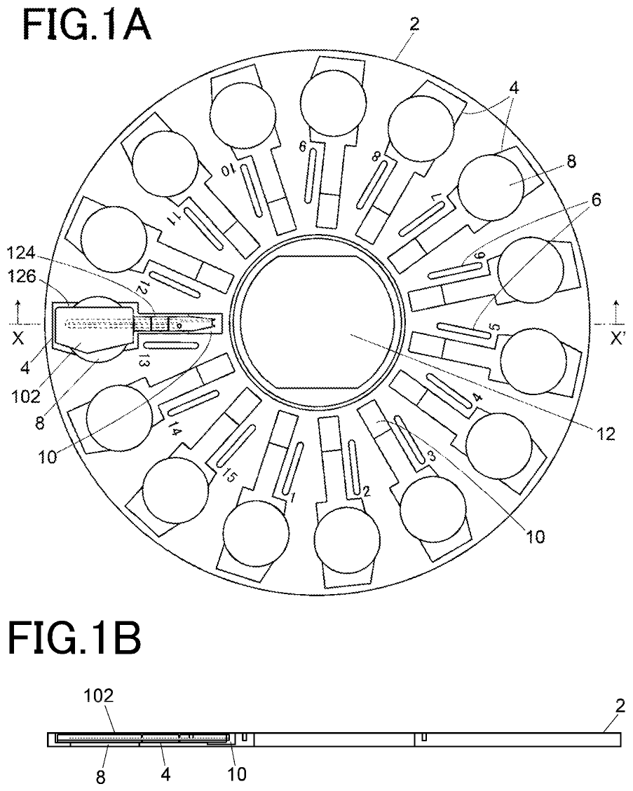

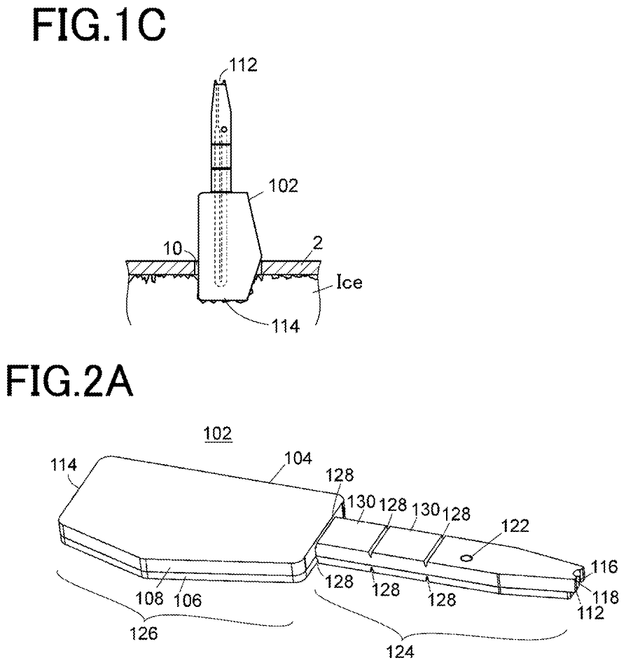

Next, one embodiment of a sample holding disc configured to store the above-mentioned sampling tip and install the sampling tip in a centrifuge will be described with reference to FIGS. 1A to 1C.

A sample holding disc 2 of this embodiment includes a disk-shaped substrate 2. A plurality of holders 4 for centrifugation and a plurality of holders 6 for keeping corresponding to the holders 4 for centrifugation are provided on an upper surface of the disk-shaped substrate 2.

The holder 4 for centrifugation is a recess in which the sampling tip 102 is fitted and held in a state where the flow channel 110 in the sampling tip 102 is substantially horizontal and the proximal end 112 side of the sampling tip 102 faces the center side of the disk-shaped substrate 2. A planar shape of the holder 4 for centrifugation corresponds to the shape of the sampling tip 102. In a portion 10 of a bottom surface of the holder 4 for centrifugation, which corresponds to the proximal end 112 of the sampling tip 102, a bottom surface of the portion 10 is lower than the other portion so that the proximal end 112 does not come into contact with the portion 10.

A through hole 8 is formed in a portion corresponding to the wide portion 126 when the sampling tip 102 is fitted in the holder 4 for centrifugation. The through hole 8 is used when the sampling tip 102 is fitted in the holder 4 for centrifugation, and when the sampling tip 102 is taken out from the holder 4 for centrifugation after centrifugation.

The holder 6 for keeping is a through groove in which the distal end 114 of the sampling tip 102 is fitted and held in a state where the flow channel 110 in the sampling tip 102 is disposed in a substantially vertical direction and the proximal end 112 faces upward. The through groove forming the holder 6 for keeping is provided with a dimension in such a way that the distal end 114 of the sampling tip 102 is inserted into the through groove, and the sampling tip 102 can be held vertically upright. If the width dimension of the holder 6 for keeping is approximately the same as the thickness dimension of the distal end 114 of the sampling tip 102, the sampling tip 102 can be stably held. However, if the sampling tip 102 can be held vertically upright, the width dimension of the holder 6 for keeping may be larger than the thickness dimension of the distal end 114.

The holder 6 for keeping in this embodiment is a through groove capable of causing the distal end 114 of the sampling tip 102 to reach a height equal to or lower than a lower surface of the sample holding disc 2. If the distal end 114 of the sampling tip 102 can reach the height lower than the lower surface of the sample holding disc 2 when the sampling tip 102 is inserted into the holder 6 for keeping, when the sample holding disc 2 is placed on ice as shown in FIG. 1C, the distal end 114 of the sampling tip 102 can be inserted into the ice, so that the sample can be cooled efficiently. The holder 6 for keeping does not necessarily have to be a through groove, and may be a nonpenetrating groove.

The through groove forming the holder 6 for keeping can be used as a jig used when the sampling tip 102 is broken at the cutting portion 128 to take out the extraction portion 130. When the sampling tip 102 is broken, the proximal end 112 or the distal end 114 of the sampling tip 102 is inserted into the through groove forming the holder 6 for keeping to fix the proximal end 112 or the distal end 114 of the sampling tip 102, whereby it becomes easy to break the sampling tip 102 at the cutting portion 128.

Identification numbers are given near each set of the holder 4 for centrifugation and the holder 6 for keeping. Thus, the sampling tip 102 is easily managed.

FIGS. 1A and 1B show a state where the sampling tip 102 is fitted in one holder 4 for centrifugation. When the sample holding disc 2 is used for centrifugal processing, the sampling tips 102 are fitted and held in some or all of the holders 4 for centrifugation, and when the sample holding disc 2 is used for storing the sampling tip 102, the distal ends of the sampling tips 102 are fitted and held in some or all of the holders 6 for keeping.

In this embodiment, although the holders 4 for centrifugation and the holders 6 for keeping are respectively provided at 15 locations, the number thereof may be any number.

In order to attach the sample holding disc 2 to a centrifuge, a hole 12 for fixing a rotation shaft is formed at the center of the sample holding disc 2. A shape of the hole 12 corresponds to a shape of the rotation shaft of the centrifuge, and the sample holding disc 12 is rotated with the rotation shaft by inserting the rotation shaft into the hole 12.

As an example of a method of using the sample holding disc 2, there is a method of stacking a plurality of the sample holding discs 2 in a state of holding the sampling tip 102, overlapping, on the uppermost sample holding disc 2, an empty sample holding disc 2 not holding the sampling tip 102, and attaching the sample holding disc 2 to the centrifuge. By using the sample holding disc 2 in this manner, when the centrifuge is operated to rotate the sample holding disc 2, the centrifugal force acts on the sampling tip 102 outward from the center of rotation, centrifugal force acts on the sampling tip 102 outward from the center of rotation. However, since the lower surface of the sample holding disc 2 overlapped on the sampling tip 102 of the holder 4 for centrifugation is present on the sampling tip 102, the sampling tip 102 can be prevented from jumping out of the sample holding disc 2 in the direction of the centrifugal force.

### DESCRIPTION OF REFERENCE SIGNS

2: Sample holding disc
4: Holder for centrifugation
6: Holder for keeping
8: Through hole
10: Portion (not in contact with proximal end of sampling tip)
12: Hole
102: Sampling tip
104: Tip body
110: Flow channel
110a, 110b: Flow channel portion
110c: Introduction flow channel
112: Proximal end
114: Distal end
116: Sample intake port
122: Air hole
128: Cutting portion
130, 130a, 130b: Extractor

1. A sample holding disc for centrifugation comprising:
a disk-shaped substrate;
a plurality of holders for centrifugation comprising a recess provided on an upper surface of the disk-shaped substrate to fit a sampling tip, the sampling tip having an opening, serving as a sample intake port, at its proximal end and including a flow channel holding a sample drawn from the opening, the flow channel having two flow channel portions connected on a distal end side and extending from the distal end side to a proximal end side, one of the flow channel portions leading to the sample intake port, the other flow channel portion terminating at a position not reaching the proximal end, the holder for centrifugation being configured such that the sampling tip is fitted in a state where the flow channel of the sampling tip is substantially horizontal and the proximal end side faces the center; and
a holder for keeping which comprises a groove provided corresponding to each of the holders for centrifugation on the upper surface of the disk-shaped substrate and in which the distal end side of the sampling tip is fitted and held in a state where the proximal end of the sampling tip faces upward.

2. The sample holding disc for centrifugation according to claim 1, wherein the holder for keeping is a through groove capable of causing the distal end of the sampling tip to reach a height equal to or lower than a lower surface of the disk-shaped substrate.

3. The sample holding disc for centrifugation according to claim 1, wherein identification information is attached to each of the holders for storage so as to be distinguishable from other holders for storage.

4. The sample holding disc for centrifugation according to claim 1, wherein a portion of a bottom surface of the holder for centrifugation, which corresponds to the proximal end of the sampling tip, is lower than the other portion so that the portion does not come into contact with the proximal end of the sampling tip.

5. The sample holding disc for centrifugation according to claim 1, wherein a hole for fixing a rotation shaft is provided at a central portion of the disk-shaped substrate.
